(19) United States
(12) Patent Application Publication
(10) Pub. No.: US 2003/0046130 A1
(43) Pub. Date: Mar. 6, 2003

(54) System and method for real-time enterprise optimization

(76) Inventors: Robert S. Golightly, Austin, TX (US); John P. Havener, Liberty Hill, TX (US); Ray D. Johnson, Georgetown, TX (US); James D. Keeler, Austin, TX (US); Ralph B. Ferguson, Round Rock, TX (US)

Correspondence Address: Jeffrey C. Hood, Conley, Rose, & Tayon, P.C., P.O. Box 398, Austin, TX, 78767, US

(21) Appl. No.: 10/225,093

(22) Filed: Aug. 21, 2002

Related U.S. Application Data
(60) Provisional application No. 60/314,749, filed on Aug. 24, 2001.

(51) Int. Cl. G06F 17/60

(52) U.S. Cl. 705/7

(57) ABSTRACT

System and method for asynchronous distributed optimization of an enterprise. The system includes multiple computer systems coupled over a network, which store and implement multiple models, including one or more dynamic models representing respective sub-systems or processes of the enterprise. At least two of the models are interdependent. The system also includes an optimizing system that includes multiple optimizers, at least two of which are interdependent, and constraints and/or objectives, and is operable to receive information related to the enterprise from multiple information sources, and use one or more of the plurality of models to generate a solution subject to the one or more constraints and/or objectives, which is usable in managing the enterprise. Some or all of the system operates in an asynchronous manner. Various portions of the system, e.g., the models, data sources, optimizers, constraints and/or objectives, etc., may be updated, e.g., asynchronously, as desired.

### PRIORITY DATA

This application claims benefit of priority of U.S. Provisional Application Serial No. 06/314,749 titled “System and Method For Real-Time Economic Optimization” and filed Aug. 24, 2001, whose inventors are Robert S. Golightly, John P. Havenar, Ray D. Johnson, and James D. Keeler.

### DESCRIPTION OF THE RELATED ART

Many systems or processes in science, engineering, and business are characterized by the fact that many different inter-related parameters contribute to the behavior of the system or process. It is often desirable to determine values or ranges of values for some or all of these parameters which correspond to beneficial behavior patterns of the system or process, such as safety, profitability, efficiency, etc. However, the complexity of most real world systems generally precludes the possibility of arriving at such solutions analytically, i.e., in closed form. Therefore, many analysts have turned to predictive models and optimization techniques to characterize and derive solutions for these complex systems or processes.

Predictive models generally refer to any representation of a system or process which receives input data or parameters related to system or model attributes and/or external circumstances/environment and generates output indicating the behavior of the system or process under those parameters. In other words, the model or models may be used to predict behavior or trends based upon previously acquired data. There are many types of predictive models, including linear, non-linear, analytic, and empirical models, among others, several types of which are described in more detail below.

Optimization generally refers to a process whereby past (or synthesized) data related to a system or process are analyzed or used to select or determine optimal parameter sets for operation of the system or process. For example, the predictive models mentioned above may be used in an optimization process to test or characterize the behavior of the system or process under a wide variety of parameter values. The results of each test may be compared, and the parameter set or sets corresponding to the most beneficial outcomes or results may be selected for implementation in the actual system or process.

FIG. 1A illustrates a general optimization process as applied to an industrial process 104, such as a manufacturing plant, according to the prior art. It may be noted that the optimization techniques described with respect to the manufacturing plant are generally applicable to all manner of systems and processes.

As FIG. 1A shows, the operation of the process 104 generates information or data 106 which is typically analyzed and/or transformed into useful knowledge 108 regarding the system or process. For example, the information 106 produced by the process 104 may comprise raw production numbers for the plant which are used to generate knowledge 108, such as profit, revenue flow, inventory depth, etc. This knowledge 108 may then be analyzed in the light of various goals and objectives 112 and used to generate decisions 110 related to the operation of the system or process 104 subject to various goals and objectives 112 specified by the analyst. As used herein, an “objective” may include a goal or desired outcome of an optimization process. Example goals and objectives 112 may include profitability, schedules, inventory levels, cash flow, revenue growth, risk, or any other attribute which the user may wish to minimize or maximize. These goals and objectives 112 may be used to select from among the possible decisions 110, where the decisions may comprise various parameter values over which the user may exercise control. The selected decision(s) may then determine one or more actions 114 to be applied to the operation of the system or process 104. The subsequent operation of the system or process 104 then generates more information 106, from which further knowledge 108 may be generated, and so on in an iterative fashion. In this way, the operation of the process 104 may be “tuned” to perform in a manner which most closely meets the goals and objectives of the business or enterprise.

FIG. 1B illustrates an optimization system where a computer based optimization system 102 operates in conjunction with a process 104 to optimize the process, according to the prior art. In other words, the computer system 102 executes software programs (including computer based predictive models) which receive process data 106 from the process 104 and generate optimized decisions and/or actions which may then be applied to the process 104 to improve operations based on the goals and objectives.

Thus, many predictive systems may be characterized by the use of an internal model which represents a process or system 104 for which predictions are made. FIG. 2A illustrates a number of predictive model types usable in optimization systems, according to the prior art. As mentioned above, predictive model types may be linear, non-linear, stochastic, or analytical, among others. However, for complex phenomena non-linear models may generally be preferred due to their ability to capture non-linear dependencies among various attributes of the phenomena. Examples of non-linear models may include neural networks and support vector machines (SVMs).

As FIG. 2A shows, the types of models used in optimization systems include fundamental or analytic models 202 which use known information about the process 104 to predict desired unknown information, such as product conditions and product properties. A fundamental model may be based on scientific and engineering principles. Such principles may include the conservation of material and energy, the equality of forces, and so on. These basic scientific and engineering principles may be expressed as equations which are solved mathematically or numerically, usually using a computer program. Once solved, these equations may give the desired prediction of unknown information.

Conventional computer fundamental models have significant limitations, such as:

(1) They may be difficult to create since the process may be described at the level of scientific understanding, which is usually very detailed;

(2) Not all processes are understood in basic engineering and scientific principles in a way that may be computer modeled;

(3) Some product properties may not be adequately described by the results of the computer fundamental models; and

(4) The number of skilled computer model builders is limited, and the cost associated with building such models is thus quite high.

These problems result in computer fundamental models being practical only in some cases where measurement is difficult or impossible to achieve.

As also shown in FIG. 2A, empirical models 204, also referred to as computer-based statistical models, may be used to model the system or process 104 in an optimization system. Such models typically use known information about process to determine desired information that may not be easily or effectively measured. A statistical empirical model may be based on the correlation of measurable process conditions or product properties of the process. Examples of computer-based empirical or statistical models include neural networks and support vector machines (SVMs).

For one example of a use of a computer-based statistical model, assume that it is desired to be able to predict the color of a plastic product. This is very difficult to measure directly, and takes considerable time to perform. In order to build a computer-based statistical model which may produce this desired product property information, the model builder would need to have a base of experience, including known information and actual measurements of desired unknown information. For example, known information may include the temperature at which the plastic is processed. Actual measurements of desired unknown information may be the actual measurements of the color of the plastic.

A mathematical relationship (i.e., an equation) between the known information and the desired unknown information may be created by the developer of the empirical statistical model. The relationship may contain one or more constants (which may be assigned numerical values) which affect the value of the predicted information from any given known information. A computer program may use many different measurements of known information, with their corresponding actual measurements of desired unknown information, to adjust these constants so that the best possible prediction results may be achieved by the empirical statistical model. Such a computer program, for example, may use non-linear regression.

Computer-based statistical models may sometimes predict product properties which may not be well described by computer fundamental models. However, there may be significant problems associated with computer statistical models, which include the following:

(1) Computer statistical models require a good design of the model relationships (i.e., the equations) or the predictions may be poor;

(2) Statistical methods used to adjust the constants typically may be difficult to use;

(3) Good adjustment of the constants may not always be achieved in such statistical models; and

(4) As is the case with fundamental models, the number of skilled statistical model builders is limited, and thus the cost of creating and maintaining such statistical models is high.

As FIG. 2A also shows, predictive model types also include procedural or recipe based models 206. These models typically comprise a number of steps whose performance emulates or models the phenomenon or process. Thus, procedural or recipe models are not based on understanding of the fundamental processes of a system, but instead, are generally constructed with an empirical or emulative approach.

Generally, a model is trained with training data, e.g., historical data, in order to reflect salient attributes and behaviors of the phenomena being modeled. In the training process, sets of training data may be provided as inputs to the model, and the model output may be compared to corresponding sets of desired outputs. The resulting error is often used to adjust weights or coefficients in the model until the model generates the correct output (within some error margin) for each set of training data. The model is considered to be in “training mode” during this process. After training, the model may receive real-world data as inputs, and provide predictive output information which may be used to control or make decisions regarding the modeled phenomena.

FIG. 2B is a flowchart of the use of a predictive model, according to the prior art. As FIG. 2B shows, in step 222, historical data is gathered, e.g., information generated by the system or process 104 in previous operations. In step 224, the historical data is preprocessed to put the data into a form useful for creating and/or training a predictive model. In step 226, the predictive model is created and/or trained. As mentioned above, the predictive model could be any of a variety of model types, depending upon the particular application and/or available resources.

In step 228, the model may be analyzed. In other words, various tools may be applied to discover the behavior of the model. In response to this analysis, the model may be modified or tuned to more accurately represent the phenomenon, system, or process being modeled.

Finally, in step 230, the model is deployed. For example, the model may be included in an optimization system 100 which is coupled to a real world process or system 104, as described above with reference to FIGS. 1A and 1B.

In one application of optimization techniques, predictive models may be used by a decision-maker associated with a business to select an optimal course of action or optimal course of decision. The optimal course of action or decision may include a sequence or combination or actions and/or decisions. For example, optimization may be used to select an optimal course of action for marketing one or more products to one or more customers. As used herein, a “customer” may include an existing customer, a former customer, and/or a prospective customer of the business. As used herein, a “customer” may include one or more persons, one or more organizations, or one or more business entities. As used herein, the term “product” is intended to include various types of goods or services, such as books, music, content subscription services, furniture, online auction items, clothing, ISP service, consumer electronics, travel, software, pharmaceutical or medical supplies, computer systems, etc., or various services such as loans (e.g., credit card, auto, mortgage, and home re-financing loans), securities (e.g., CDs, retirement accounts, cash management accounts, and mutual funds), or insurance (e.g., life, health, auto, and home owner's insurance), among others. For example, customers may include credit customers to whom credit services are marketed, or customers may include pharmaceutical customers to whom pharmaceutical products are marketed.

As used herein, “decision variables” are those variables that the decision-maker may change to affect the outcome of the optimization process 100. For example, in an optimization of a credit card offer conducted by a credit card issuer, Annual Percentage Rate (APR) and credit limit may be decision variables. As used herein, “external variables” are those variables that are not under the control of the decision-maker. In other words, the external variables are not changed in the decision process but rather are taken as givens. For example, external variables may include variables such as customer addresses, customer income levels, customer demographic information, bureau data, transaction file data, cost of funds and capital, and other suitable variables.

Generally, a business may desire to apply the optimal course of action or optimal course of decision to one or more customer relationships to increase the value of customer relationships to the business. As used herein, a “portfolio” includes a set of relationships between the business and a plurality of customers. In general, the process of optimization may include determining which variables in a particular problem are most predictive of a desired outcome, and what treatments, actions, or mix of variables under the decision-maker's control (i.e., decision variables) may optimize the specified value. The one or more products may be marketed to customers in accordance with the optimal course of action, such as through direct mailing and/or targeted advertising. Other means of applying the optimal course of action may include, for example, conducting a re-pricing campaign in accordance with the optimal course of action, conducting an acquisition campaign in accordance with the optimal course of action, conducting an e-mailing campaign in accordance with the optimal course of action, and conducting a promotional campaign in accordance with the optimal course of action.

FIG. 2C is a block diagram of a predictive model 215 as used in an optimization system 100, according to the prior art. As FIG. 2C shows, the model 215 may receive input in the form of external variables 212 and decision variables 214, defined above, and generate action variable 218. As used herein, “action variables” are those variables that propose or suggest a set of actions for an input set of decision and external variables. In other words, the action variables may comprise predictive metrics for a behavior. For example, in the optimization of a product marketing campaign, the action variables may include the probability of a customer's response to an offer. In a re-pricing campaign, the action variables may include the likelihood of a customer maintaining a service after re-pricing the service. In the optimization of a credit card offer, the action variables may include predictions of balance, attrition, charge-off, purchases, payments, and other suitable behaviors for the customer of a credit card issuer.

Thus, predictive models may be used for analysis, control, and decision making in many areas, including manufacturing, process control, plant management, quality control, optimized decision making, e-commerce, financial markets and systems, or any other field where predictive modeling may be useful. For example, quality control in a manufacturing plant is increasingly important. The control of quality and the reproducibility of quality may be the focus of many efforts. For example, in Europe, quality is the focus of the ISO (International Standards Organization, Geneva, Switzerland) 9000 standards. These rigorous standards provide for quality assurance in production, installation, final inspection, and testing. They also provide guidelines for quality assurance between a supplier and customer.

The quality of a manufactured product is a combination of all of the properties of the product which affect its usefulness to its user. Process control is the collection of methods used to produce the best possible product properties in a manufacturing process, and is very important in the manufacture of products. Improper process control may result in a product which is totally useless to the user, or in a product which has a lower value to the user. When either of these situations occur, the manufacturer suffers (1) by paying the cost of manufacturing useless products, (2) by losing the opportunity to profitably make a product during that time, and (3) by lost revenue from reduced selling price of poor products. In the final analysis, the effectiveness of the process control used by a manufacturer may determine whether the manufacturer's business survives or fails. For purposes of illustration, quality and process control are described below as related to a manufacturing process, although process control may also be used to ensure quality in processes other than manufacturing, such as e-commerce, portfolio management, and financial systems, among others.

FIGS. 3A and 3B illustrate a general optimization system and process using predictive models with an optimizer to generate optimal decision variables, according to the prior art.

FIG. 3A is a block diagram which illustrates an overview of optimization according to the prior art. As shown in FIG. 3A, an optimization process 100 may accept the following elements as input: information 302, such as customer information records 302, predictive model(s) such as customer model(s) 304, one or more constraints and/or objectives 306. As used herein, a “constraint” may include a limitation on the outcome of an optimization process. Constraints are typically “real-world” limits on the decision variables and are often critical to the feasibility of any optimization solution. Managers who control resources and capital or are responsible for financial effects or results may be involved in setting constraints that accurately represent their real-world environments. Setting constraints with management input may realistically restrict the allowable values for the decision variables. The optimization process 100 may produce as output an optimized set of decision variables 312. In a customer-based example, each of the predictive model(s) 304 may be a customer model, and may correspond to a different customer information record 302.

FIG. 3B illustrates data flow in the optimization system of FIG. 3A. As FIG. 3B shows, the customer information 202 typically includes decision variables 214 and external variables 212, as described above. The customer information 302, including decision variables 214 and external variables 212, is input into the predictive model(s) 304 to generate the action variables 218. In this example, each of the predictive model(s) 304 corresponds to one of the customer information records 302, where each of the customer information records 302 includes appropriate decision variables 214 and external variables 212. The predictive model(s) 304 may include customer model(s) as well as other models. The predictive model(s) 304 can take any of several forms, as described above, including trained neural nets, statistical models, analytic models, and any other suitable models for generating predictive metrics, and may take various forms including linear or non-linear, or may be derived from empirical data or from managerial judgment.

As FIG. 3B shows, the action variables 218 generated by the model(s) 304 are used to formulate constraint(s) and the objective function 306 via formulas. For example, a data calculator 320 generates the constraint(s) and objective 306 using the action variables 218 and potentially other data and variables. The formulations of the constraint(s) and objective 306 may include financial formulas such as formulas for determining net operating income over a certain time period. The constraint(s) and objective 306 may be input into an optimizer 324, which may comprise, for example, a custom-designed process or a commercially available “off the shelf” product. The optimizer may then generate the optimal decision variables 312 which have values optimized for the goal specified by the objective function and subject to the constraint(s) 306. A further understanding of the optimization process 100 may be gained from the references “An Introduction to Management Science: Quantitative Approaches to Decision Making”, by David R. Anderson, Dennis J. Sweeney, and Thomas A. Mayiams, West Publishing Co. (1991); and “Fundamentals of Management Science” by Efraim Turban and Jack R. Meredith, Business Publications, Inc. (1988).

### SUMMARY

Various embodiments of a system and method for asynchronous distributed optimization of an enterprise are presented. The system may be referred to as a real-time enterprise optimization (REO) system. The enterprise may relate to one or more of: manufacturing, polymer production, chemical production, energy production, energy distribution, financial services, and engineering, among others. For example, embodiments of the invention may be used in various fields, including chemicals, polymers, energy generation and distribution, pulp and paper, consumer goods, cement, minerals, mining, and service enterprises, including, for example, financial, management, diagnostic, analysis, distribution, and engineering services, among many others.

The system may include a plurality of computer systems coupled together over a network, e.g., a Local Area Network (LAN), or a Wide Area Network (WAN), such as the Internet. The plurality of computer systems may store and implement a plurality of models, including one or more dynamic models representing respective sub-systems or processes of the enterprise. At least two of the plurality of models may be interdependent. In one embodiment, two or more of the models may comprise an aggregate model. The plurality of models may include any of a variety of model types, such as, for example, a neural network, a support vector machine, an analytic model, a statistical model, a regression model, an empirical model, a first principals model, a non-linear model, a rule-based model, and an expert system model, among others. Some models may also be combinations of any of the above model types.

The system may also include an optimizing system, operable to receive information related to the enterprise from a plurality of information sources, and to use one or more of the plurality of models to generate a solution, where the solution is usable in managing the enterprise. At least a portion of the system may operate in an asynchronous manner. In other words, various components and/or processes in the system may communicate and/or operate without mutual timing requirements, schedules, or constraints. Said yet another way, some portions of the system may not operate synchronously with respect to one another.

As mentioned above, the system may be distributed over the plurality of computer systems. For example, the plurality of models may be stored and/or executed on a first subset of the plurality of computer systems, and the optimizing system may be stored and/or executed on a second subset of the plurality of computer systems. The first and second subsets of the plurality of computer systems may have no computer systems in common, or may have at least one computer system in common. Additionally, in one embodiment, the plurality of information sources may be comprised on two or more computer systems. Thus, the various components of the system may be distributed across the plurality of computer systems in any manner desired.

In one embodiment, the optimizing system may include a plurality of optimizers, where at least a subset of the plurality of optimizers are interdependent. The optimizing system may also include one or more constraints and/or objectives, wherein the optimizing system is operable to generate the solution subject to the one or more constraints and/or objectives. In one embodiment, the one or more constraints and/or objectives may include two or more interdependent constraints and/or objectives. In various embodiments, portions of the solution may be implementable by a human, by software, i.e., programmatically, or both, to manage the enterprise.

In some embodiments, various of the components may overlap in functionality. For example, at least one of the models may comprise one of the plurality of information sources. Or, at least one of the models may comprise one of the one or more constraints and/or objectives. As yet another example, at least one of the information sources may comprise one of the one or more constraints and/or objectives.

In one embodiment, at least two of the models may comprise dynamic models. In other words, at least a portion of the plurality of models may be updated more than annually. Similarly, the optimizing system may be updated more often than once per annum. For example, the dynamic models and/or the optimizing system may be updated one or more of: at least twice per annum, at least once per month, at least twice per month, at least weekly, at least daily, at least hourly, at least once per minute, at least once per second, and at least once per millisecond. It is noted that the particular rates of update for the dynamic models and/or the optimizing system are application dependent, e.g., are dependent upon the timing and rate-of-change characteristics of the managed system or process.

In one embodiment, the system may be operable to programmatically retrieve input information. For example, the system may be operable to monitor input information from the one or more information sources and detect changes in data/information from the plurality of information sources. If a value or change in value in an element of the input information matches one or more criteria, the system may retrieve the element, and update one or more of the dynamic models, and/or the optimizing system, in response to the detected changes, and in accordance with the retrieved element. Additionally, the plurality of models and/or the optimizing system may be operable to programmatically retrieve input information and dynamically update the plurality of models and/or the optimizing system in an asynchronous manner.

The models used by a real-time enterprise optimization system, such as the Pavilion REO™ system developed by Pavilion Technologies, Inc., may be used to model any of various systems, processes, conditions, etc., which are germane to the operations and/or performance of the enterprise. For example, the plurality of models may include one or more of: a costing model, a revenue model, a tax model, an organization model, a process model, a production model, a product model, a customer model, an equipment model, a maintenance model, a supply chain model, an economics model, an environmental model, a performance model, a logistics model, a distribution model, a sales model, a marketing model, a scheduling model, and a model of one or more of the plurality of models, among others.

The plurality of information sources may provide information related to one or more of: cost of resources, cost of capital, raw materials, enterprise operations and/or processes, network management, performance, equipment, energy, competitors, marketing, sales, product specifications, geographic location, economic factors, ambient conditions, customer information, environmental information, executive instructions, and synthesized information related to the enterprise, among others.

Additionally, any of the above types of information may include historical, current, and/or projected information. For example, the information related to energy may include one or more of current availability of energy, projected availability of energy, current price of energy, and projected price of energy. The information related to raw materials may include one or more of current availability of raw materials, projected availability of raw materials, current price of raw materials, and projected price of raw materials. Information related to sales may include one or more of current sales and projected sales. Information related to economic factors may include one or more of current and/or projected stock prices, current and/or projected debt rating, and current and/or projected interest rates, among others. Information related to equipment may include information related to one or more of equipment performance, equipment maintenance, and equipment status. Thus, the information received and used by various components of the REO system may include any type of information, past, present, or projected (i.e., predicted), which may be related to enterprise operations and/or performance.

In one embodiment of the present invention, the plurality of models and the optimizing system may be operable to receive information related to the enterprise from the plurality of information sources, and use one or more of the plurality of models to generate a solution, where at least one of the plurality of information sources comprises one or more systems and/or process of the enterprise. In other words, some of the information sources may be internal to the enterprise. Thus, in these cases, implementing a solution may result in changes in the data from these sources. Thus, in one embodiment, the receiving information and the generating solutions may be performed iteratively. Thus, because any of the components of the REO system may communicate with one another asynchronously, changes in any of the components may propagate through the system, and so optimizing the enterprise may include iterating the optimization process to generate successive solutions. This approach may be used to, in effect, optimize the enterprise in a substantially continuous or on-going manner. In another use of this approach, the optimization process may be performed iteratively until the solutions converge, i.e., until, in effect, a solution equilibrium is reached, or until an specified time period has elapsed.

In another embodiment of the invention, the receiving information and the generating solutions may be performed recursively. For example, in a single recursion approach, one or more of the components, e.g., the optimizers, may use its own output information as input. Thus, in effect, the process may “call itself”, much as a recursive function in a programming language. In a dual recursion approach, two components or processes, A and B, may call one another, where the output of A is used as input to B, and vice versa. Other recursion schemes, well-known in the art, are also contemplated.

In one embodiment, the system may operate in the following manner:

Information may be received from any of the plurality of information sources, including, for example, external information and/or internal information, including historical, current, and/or projected information, as well as possibly synthesized information, as described above.

Then, at least one of the plurality of models may be updated in accordance with the received information. For example, data, parameters, and/or coefficients of a model may be updated. In another embodiment, one or more models may be added, removed, or replaced, depending on the information received. In other embodiments, other components of the REO system may be updated, including, for example, the information or data sources, the optimizers, and/or the constraints and/or objectives, among others. In other words, any component or aspect of the REO system may be updated as desired. As mentioned above, in some embodiments, such updates may be performed asynchronously.

At least a portion of the received information may be input to the optimizing system (e.g., optimizers and/or constraints and/or objectives). For example, in one embodiment, the received information may include updated objectives and/or constraints which may affect the solution(s) generated by the optimizer(s).

Then, the optimizing system (e.g., one or more of the optimizers) may execute one or more of the plurality of models to generate the solution, as indicated in. As noted earlier, the optimizing system preferably generates the solution subject to the one or more objectives and/or constraints. The solution may be any type of information or decision that is germane to enterprise operations. For example, the solution may include one or more of: production schedules, product pricing, investment strategies, diagnoses, product mixes, and/or any type of management decision, plan, or strategy, among others.

Finally, the solution may be implemented, e.g., to manage the enterprise. In other words, as mentioned above, the solution may be implemented by human actions, programmatically, or a combination of the two.

Thus, various embodiments of the distributed asynchronous enterprise optimization systems and method described herein may provide improved means for enterprise-wide optimization. More specifically, the fact that the components of the system may be distributed across multiple computers, and which may communicate and operate asynchronously over a network, e.g., the Internet, may allow for flexible, integrated, and substantially real-time, optimization of heterogeneous systems and operations of an enterprise. Moreover, a modular architecture of the system may allow easy customization of the system for specific applications or types of enterprise.

### BRIEF DESCRIPTION OF THE DRAWINGS

A better understanding of the present invention can be obtained when the following detailed description of various embodiments is considered in conjunction with the following drawings, in which:

FIG. 1A illustrates a general optimization process as applied to an industrial process 104, such as a manufacturing plant, according to the prior art;

FIG. 1B illustrates an optimization system where a computer based optimization system 102 operates in conjunction with a process 104 to optimize the process, according to the prior art;

FIG. 2A illustrates a number of predictive model types usable in optimization systems, according to the prior art;

FIG. 2B is a flowchart of the use of a predictive model, according to the prior art;

FIG. 2C is a block diagram of a predictive model 215 as used in an optimization system 100, according to the prior art;

FIGS. 3A and 3B illustrate a general optimization system and process using predictive models with an optimizer to generate optimal decision variables, according to the prior art;

FIG. 4A illustrates an optimization system where a computer based optimization system 402 operates in conjunction with a process 404 and a dynamic model feedback 406 to optimize the process, according to one embodiment;

FIG. 4B illustrates a distributed asynchronous enterprise optimization system, according to one embodiment of the invention;

FIG. 5 is a flowchart diagram illustrating operation of dynamic model feedback methods, according to one embodiment;

FIG. 6 is a diagram illustrating a general hierarchy of real-time enterprise optimization, according to one embodiment; and

FIG. 7 flowcharts one embodiment of a method for optimization of an enterprise.

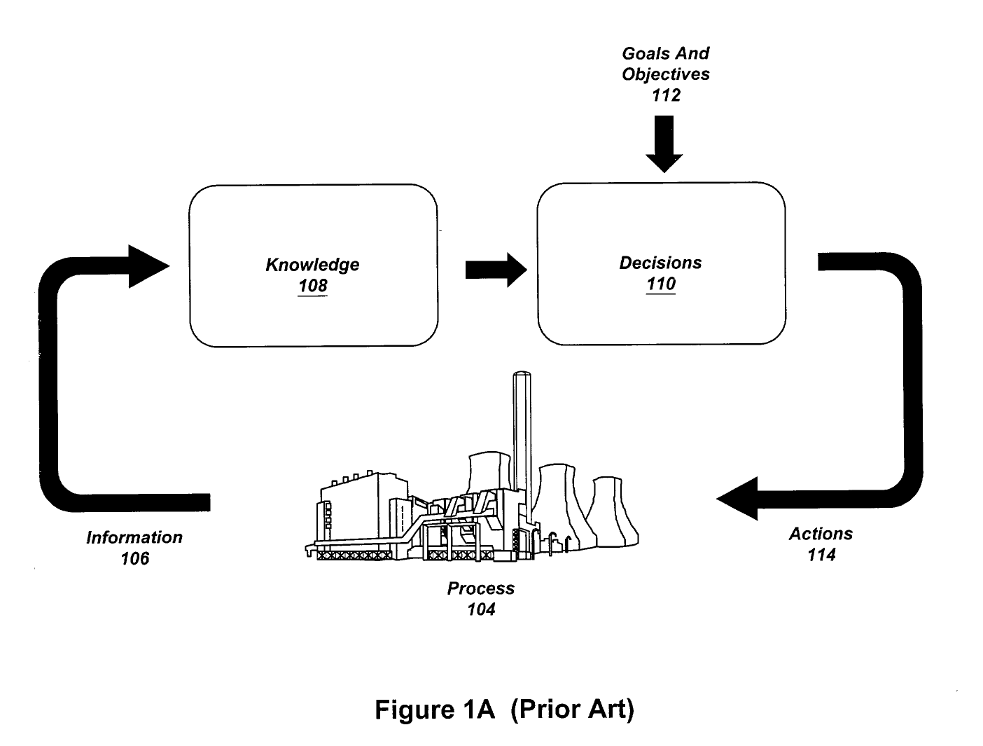

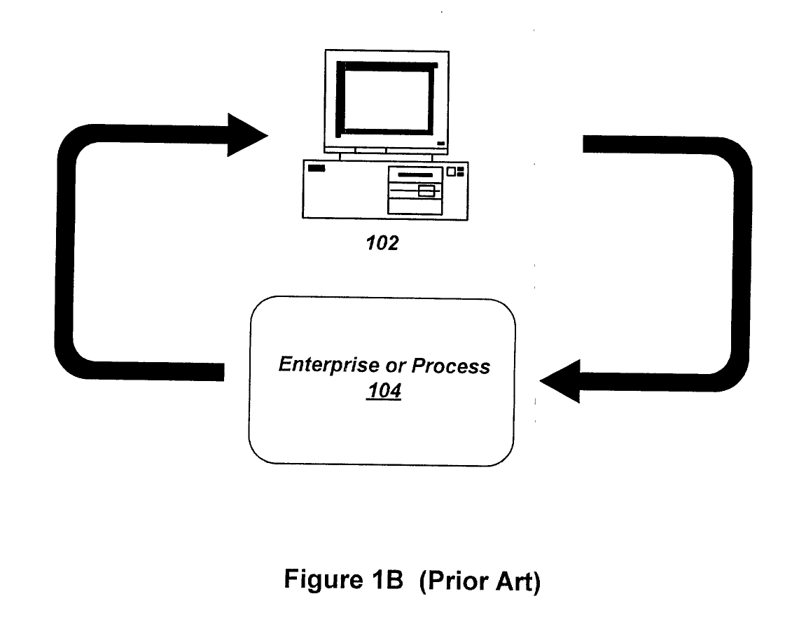

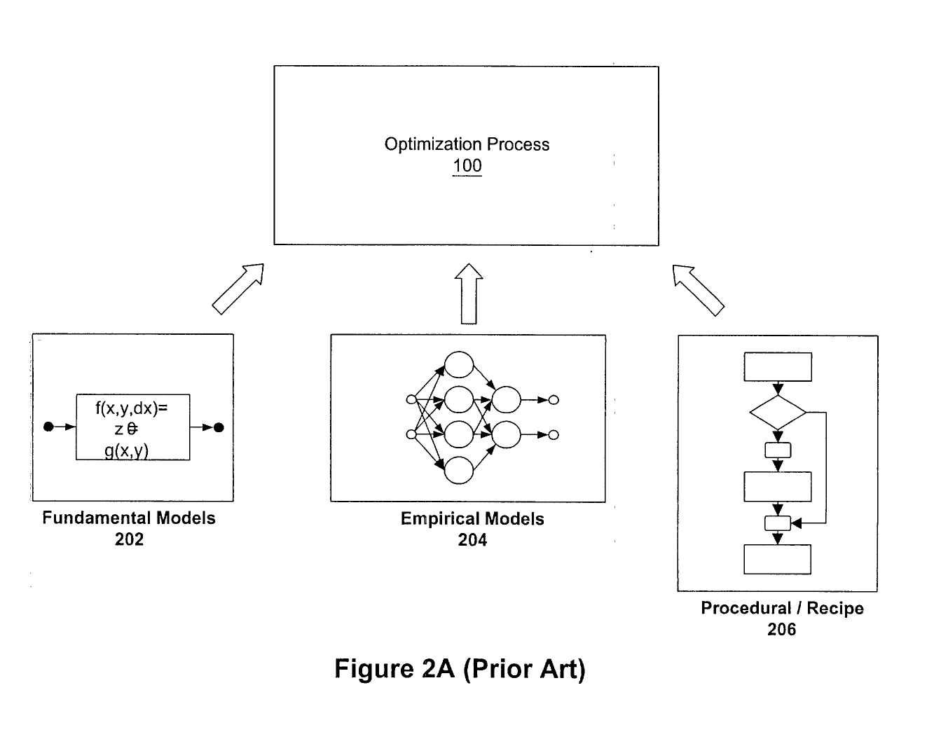

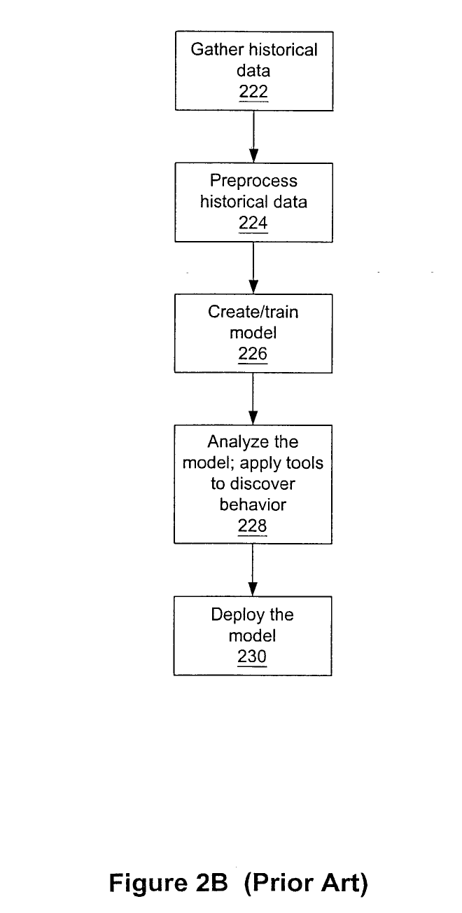

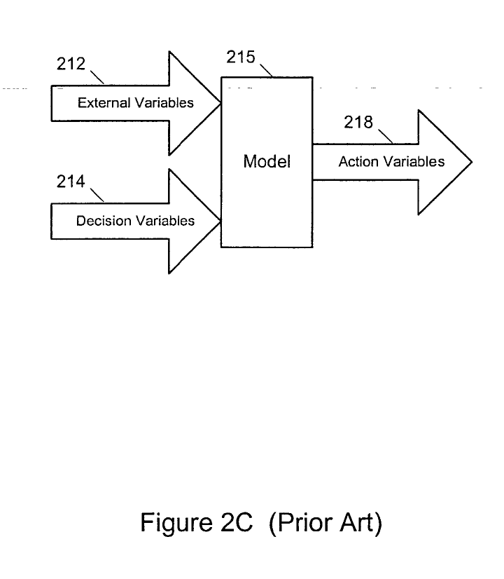

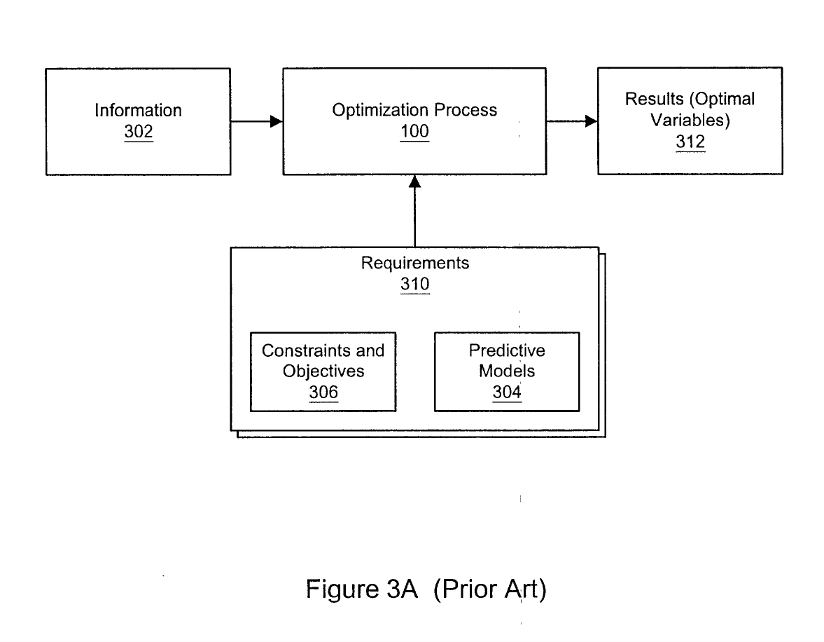

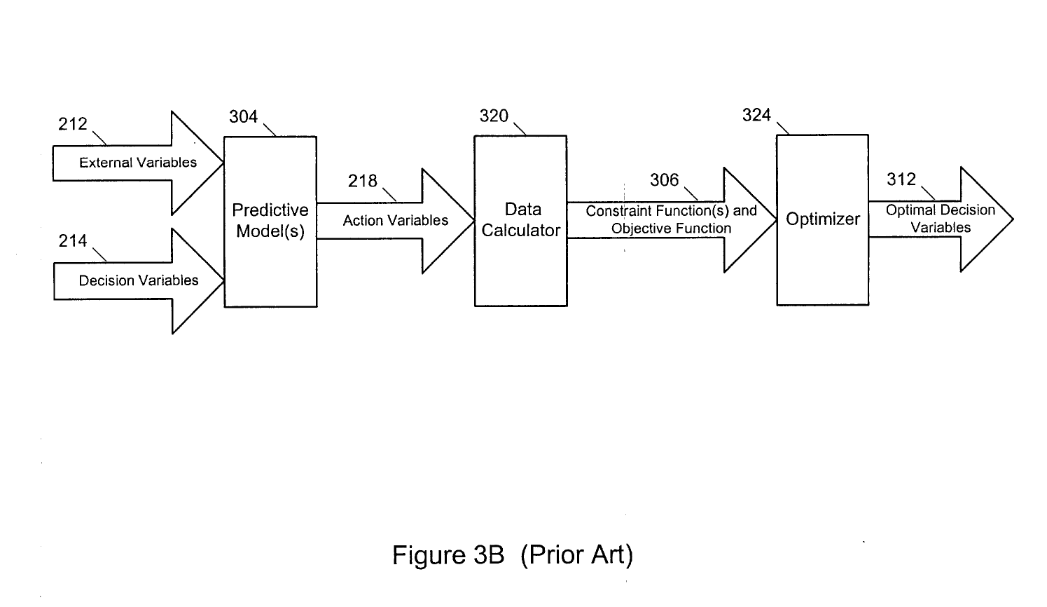

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

Incorporation by Reference

U.S. application Ser. No. 09/827,838 titled “System and Method for Enterprise Modeling, Optimization and Control” and filed Apr. 5, 2001, whose inventors are Edward Stanley Plumer, Bijan Sayyar-Rodsari, Carl Anthony Schweiger, Ralph Bruce Ferguson II, William Douglas Johnson, and Celso Axelrud, is hereby incorporated by reference as though filly and completely set forth herein.

U.S. Provisional Application Serial No. 60/382,301 titled “Dynamic Cost Accounting” and filed May 22, 2001, whose inventors are Robert S. Golightly, Edward Stanley Plumer, Graham Gaylord, and Ralph Bruce Ferguson, is hereby incorporated by reference as though fully and completely set forth herein.

U.S. Provisional Application Serial No. 60/314,749 titled “System and Method For Real-Time Economic Optimization” and filed Aug. 24, 2001, whose inventors are Robert S. Golightly, John P. Havenar, Ray D. Johnson, and James D. Keeler, is hereby incorporated by reference as though fully and completely set forth herein.

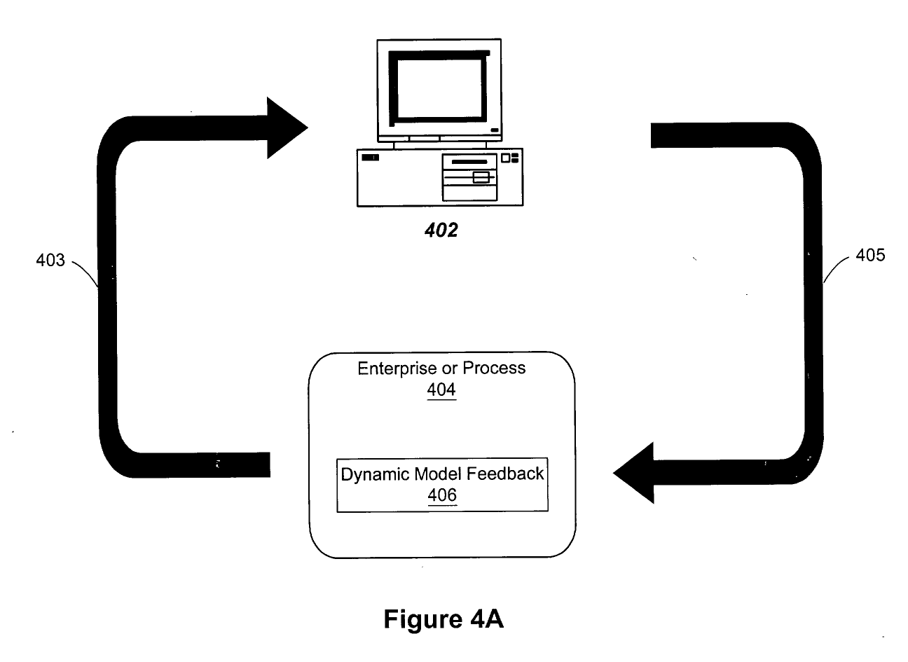

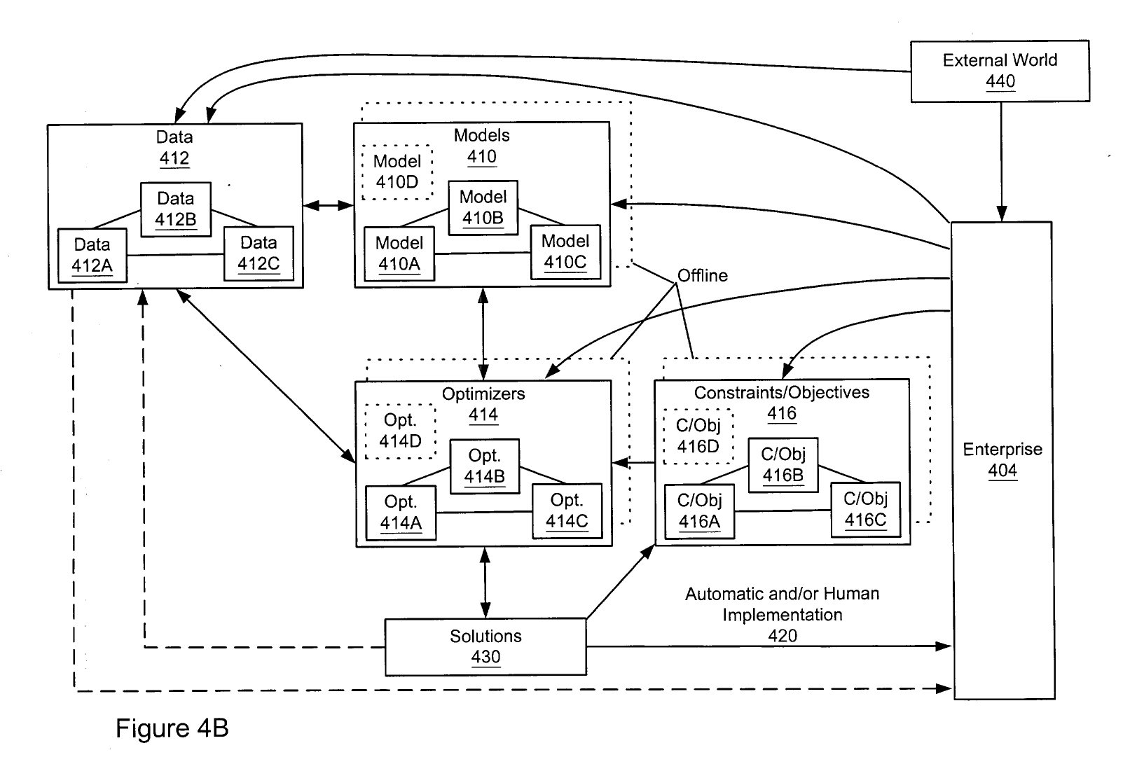

FIG. 4A: Optimization System

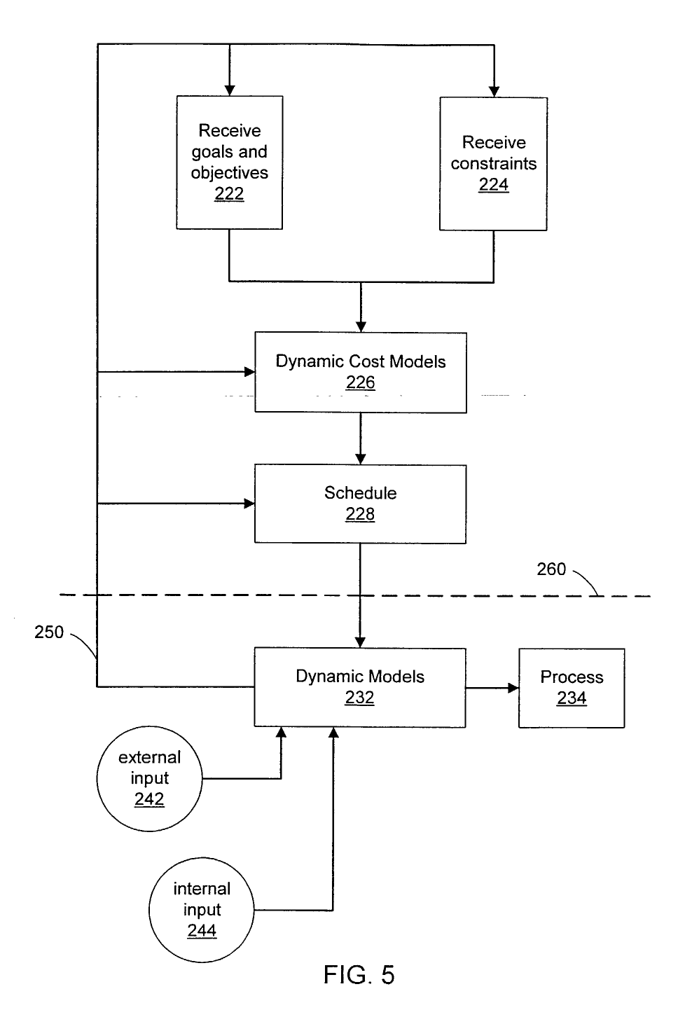

FIG. 4A illustrates an optimization system according to one embodiment of the invention where a computer based optimization system 402 operates in conjunction with an enterprise or process 404 to optimize the process. In other words, the computer system 402 executes software programs (including computer based predictive models) which receive process data from the process 404, as shown by arrow 403 and generate optimized decisions and/or actions which may then be applied to the process 104 to improve operations, as shown by arrow 405. The dynamic model feedback 406, shown within the process 404, distinguishes the invention from the prior art. The dynamic model feedback 406 allows real-time data (e.g., availability of equipment) to be used as input to generate improved versions of optimized decisions and/or actions on an event-driven basis. In turn, the improved versions of optimized decisions and/or actions may then be applied to the process 104 to improve operations. The operation of the dynamic model feedback is illustrated in detail in FIG. 5, as represented by arrows 250.

It should be noted that as used herein, the term “enterprise” may refer to any type of process, operation, business, or system which produces a physical (e.g., manufactured) or intangible (e.g., reports, analysis, advice, etc.) product, or which performs a service. For example, the enterprise may relate to one or more of: manufacturing, polymer production, chemical production, energy production, energy distribution, financial services, scientific analysis, and engineering, among others. It is further noted that the examples of enterprises listed are not intended to limit the application of the methods and/or systems described herein to any particular field, system, or process, but are merely intended to indicate the broad scope of application contemplated for various embodiments of the invention.

FIG. 4B: An Asynchronous Distributed Enterprise Optimization System

FIG. 4B is a high level block diagram illustrating one embodiment of an asynchronous distributed enterprise optimization system. More specifically, FIG. 4B illustrates the various components of a REO system and communication paths between them.

As FIG. 4B shows, the REO system may include, in addition to the enterprise 404 itself, a plurality of models 410, a plurality of information or data sources 412, a plurality of optimizers 414, and one or more constraints and/or objectives 416. The optimizers and constraints/objective may together comprise an optimizing system which, in conjunction with the models 410 and data sources 412 may be operable to generate solutions 430 which may be used to manage and/or control enterprise operations. Each of the components of the REO system may be operable to communicate with one or more of the other components, where at least a portion of the various inter-component communications and processes may occur in an asynchronous manner. In other words, at least a portion of the system may operate in an asynchronous manner, i.e., various components and/or processes in the system may communicate and/or operate without mutual timing requirements, schedules, or constraints. Said yet another way, some portions of the system may not operate synchronously with respect to one another. Additionally, the REO system may receive data from the external world 440, as shown.

As indicated in FIG. 4B, in some embodiments, various of the REO system components may comprise a plurality of elements, where at least two of the elements are interdependent. For example, at least a subset of the models 410, e.g., models 410A, 410B, and 410C, may be interdependent, where output from one model may be used as input to a another model, and possibly vice versa. In one embodiment, two or more of the models 410 may comprise an aggregate model, i.e., a model may include a plurality of sub-models. The plurality of models 410 may include any of a variety of model types, such as, for example, a neural network, a support vector machine, an analytic model, a statistical model, a regression model, an empirical model, a first principals model, a non-linear model, a rule-based model, and an expert system model, among others. Some models may also be combinations of any of the above model types.

In one embodiment, at least two of the models may comprise dynamic models. In other words, at least a portion of the plurality of models may be updated more than annually. Similarly, the optimizing system may be updated more often than once per annum. For example, the dynamic models and/or the optimizing system may be updated one or more of: at least twice per annum, at least once per month, at least twice per month, at least weekly, at least daily, at least hourly, at least once per minute, at least once per second, and at least once per millisecond. In one embodiment, the system may be operable to programmatically retrieve input information. For example, in one embodiment, the system may be operable to monitor input information from the one or more information sources and detect changes in data/information from the plurality of information sources. If a value or change in value in an element of the input information matches one or more criteria, the system may retrieve the element, and update one or more of the dynamic models, and/or the optimizing system, in response to the detected changes, and in accordance with the retrieved element. Additionally, in one embodiment, the plurality of models and/or the optimizing system are operable to programmatically retrieve input information and dynamically update the plurality of models and/or the optimizing system in an asynchronous manner.

The models used by the REO system may be used to model any of various systems, processes, conditions, etc., which are germane to the operations and/or performance of the enterprise. For example, the plurality of models may include one or more of: a costing model, a revenue model, a tax model, an organization model, a process model, a production model, a product model, a customer model, an equipment model, a maintenance model, a supply chain model, an economics model, an environmental model, a performance model, a logistics model, a distribution model, a sales model, a marketing model, a scheduling model, and a model of one or more of the plurality of models, among others.

Similar to the models, two or more of the plurality of data sources 412 may be interdependent, where data from one data source, e.g., 412B, may be derived from data comprised in other data sources, e.g., 412A and 412C. Thus, in one embodiment, one or more of the data sources 412 may comprise an aggregate data source. The various data or information sources 412 may include any source of information which may be germane to the operations and/or performance of the enterprise. For example, the plurality of information sources may provide information related to one or more of: cost of resources, cost of capital, raw materials, enterprise operations and/or processes, network management, performance, equipment, energy, competitors, marketing, sales, product specifications, geographic location, economic factors, ambient conditions, customer information, environmental information, executive instructions, and synthesized information related to the enterprise, among others. Additionally, any of the above types of information may include historical, current, and/or projected information. For example, the information related to energy may include one or more of current availability of energy, projected availability of energy, current price of energy, and projected price of energy. The information related to raw materials may include one or more of current availability of raw materials, projected availability of raw materials, current price of raw materials, and projected price of raw materials. Information related to sales may include one or more of current sales and projected sales. Information related to economic factors may include one or more of current and/or projected stock prices, current and/or projected debt rating, and current and/or projected interest rates, among others. Information related to equipment comprises information related to one or more of equipment performance, equipment maintenance, and equipment status. Thus, the information received and used by various components of the REO system may include any type of information, past, present, or projected (i.e., predicted), which may be related to enterprise operations and/or performance.

In one embodiment, the optimizing system may include a plurality of optimizers, at least a portion of which may be interdependent. In other words, at least one of the optimizers may provide its output to another optimizer as input. The plurality of optimizers may be used to optimize respective operations and/or processes of the enterprise, and at least a subset of the optimizers may operate in conjunction with one another, e.g., as an aggregate optimizer, to optimize combinations of enterprise sub-systems and/or sub-processes. The optimizing system may also include constraints and/or objectives 416, as mentioned above, where the optimizing system may be operable to generate the solution subject to the one or more constraints and/or objectives. In one embodiment, the one or more constraints and/or objectives may include at least one constraint and at least one objective. At least a subset, e.g., two or more, of the constraints and/or objectives 416 may be interdependent, as indicated in FIG. 4B. Two or more of the constraints and/or objectives 416 may be aggregated into a compound or combined constraint and/or objective 416. In one embodiment, various of the constraints and/or objectives may be in conflict with one another. For example, an objective of maximizing profit may conflict with an objective of reducing inventory or minimizing risk.

In some embodiments, various of the components may overlap in functionality. For example, at least one of the models may comprise one of the plurality of information sources. Or, at least one of the models may comprise one of the one or more constraints and/or objectives. As yet another example, at least one of the information sources may comprise one of the one or more constraints and/or objectives.

In one embodiment, one or more models 410D, shown in dashed lines, may be operated offline, e.g., in parallel with the online models 410A-410C. These offline models 410D may be run outside of the normal model execution process, and may be switched into service via human action and/or programmatically (i.e., automatically via software). For example, a condition may be detected for which one of the offline models, e.g., 410D, may be more suitable (as compared to a currently active model, e.g., 410B). The offline model 410D may then be swapped out with the active model 410B, and the system may then proceed using the newly included model 410D. In one embodiment, output from the offline model 410D may be monitored, and when the output is judged to be superior or more appropriate than that of the current or active model 410B, the model switch may be made. In another embodiment, rather than swapping the models, the offline model(s) 410D may be added to the online models (e.g., 410A-C).

Similarly, in one embodiment, one or more optimizers 414D and/or constraints/objectives 416D, also shown in dashed lines in FIG. 4B, may be operated offline, e.g., in parallel with the online optimizers 414A-414C and constraints/objectives 416A-416C. These optimizers 414D (and/or constraints/objectives 416D) may be operated independently or in parallel with the online optimization process, and, as described above with respect to the models, may be switched into service by human action and/or by software based on specified criteria or conditions as needed. The optimizers 414D and/or constraints/objectives 416D may be added to the active optimizers and constraints/objectives, or may be swapped with one or more of the active components.

In some embodiments, offline versions of entire sub-systems may be included in the REO system. For example, as FIG. 4B shows, offline versions of one or more of the models sub-system 410, the optimizers sub-system 414, and the constraints/objectives sub-system 416, may be maintained and operated in parallel with their respective online versions, as indicated by the dashed line components marked “offline”. In other words, an offline sub-system configured differently from its corresponding online sub-system may be operated offline, and based upon specified criteria or conditions, may be added to or switched with, the online sub-system.

It is noted that these parallel offline components may be used in a variety of contexts for different purposes, including, for example, prediction, simulation, analysis, and control, among others.

In a preferred embodiment, the REO system components may be distributed over a plurality of computer systems networked together over, e.g., a Local Area Network (LAN), or a Wide Area Network (WAN), such as the Internet. In other words, various subsets of the REO system functions may be performed on respective subsets of the plurality of computers. For example, the plurality of models 410 may be stored and/or executed on a first subset of the plurality of computer systems, and the optimizing system may be stored and/or executed on a second subset of the plurality of computer systems. In one embodiment, the first subset of the plurality of computer systems and the second subset of the plurality of computer systems may have no computer systems in common. Alternatively, the first subset of the plurality of computer systems and the second subset of the plurality of computer systems may have at least one computer system in common.

Other distribution schemes are also contemplated. For example, the plurality of information sources 412 may be comprised on two or more computer systems. Similarly, the other components of the REO system may be comprised respectively on two or more computer systems. Alternatively, in another embodiment, each of the components may be stored and/or implemented on a respective computer system. As mentioned above, in any of the distribution schemes, at least a portion of the inter-component communications is preferably performed asynchronously.

As FIG. 4B indicates, any of the REO system components or processes may communicate with one another and/or with processes and/or systems of the enterprise 404 itself, as well as the external world. For example, as shown in FIG. 4B, the enterprise 404 may provide data to the various components of the optimization system, including data sources 412, models 410, optimizers 414, and/or constraints/objectives 416. In an example where the enterprise is a manufacturing enterprise, the enterprise 404 may provide substantially real-time data related to production, equipment, energy use, performance, etc., to any of the other components of the REO system. Similarly, the enterprise 404 may receive information from, or be subject to effects due to, the external word 440, as shown, which may have bearing on the enterprise operations. For example, the enterprise may receive information such as interest rates, cost of raw resources, etc., or may be subject to conditions such as temperature, weather, location, etc., any of which may affect enterprise operations.

In one embodiment, once the data 412 and/or models 410 are up-to-date, one or more of the optimizers 414 may execute one or more of the models 410, possibly using data from one or more of the information sources 412, and generate one or more solutions 430 subject to one or more of the constraints and/or objectives 416, as shown in FIG. 4B. For example, in a polymer production application, the solution may comprise a production schedule which attempts to meet various objectives and/or constraints, such as, for example, minimizing late deliveries, minimizing off-spec product, etc.

In some embodiments, at least a portion of the solution may be implementable by a human to manage the enterprise. In other embodiments, at least a portion of the solution may be programmatically implementable to manage the enterprise. In other words, at least a portion of the solution may be automatically implemented, i.e., without manual human intervention. In yet other embodiments, a first portion of the solution may be programmatically implementable to manage the enterprise, and a second portion of the solution may be implementable by a human to manage the enterprise.

In one embodiment of the present invention, the plurality of models and the optimizing system may be operable to receive information related to the enterprise from the plurality of information sources, and use one or more of the plurality of models to generate a solution, where at least one of the plurality of information sources comprises one or more systems and/or process of the enterprise. In other words, some of the information sources may be internal to the enterprise. Thus, in these cases, implementing a solution may result in changes in the data from these sources. Thus, in one embodiment, the receiving information and the generating solutions may be performed iteratively. Thus, because any of the components of the REO system may communicate with one another asynchronously, changes in any of the components may propagate through the system, and so optimizing the enterprise may include iterating the optimization process to generate successive solutions. This approach may be used to, in effect, optimize the enterprise in a substantially continuous or on-going manner. In another use of this approach, the optimization process may be performed iteratively until the solutions converge, i.e., until, in effect, a solution equilibrium is reached.

In another embodiment of the invention, the receiving information and the generating solutions may be performed recursively. For example, in a single recursion approach, one or more of the components, e.g., the optimizers, may use its own output information as input. Thus, in effect, the process may “call itself”, much as a recursive function in a programming language. In a dual recursion approach, two components or processes, A and B, may call one another, where the output of A is used as input to B, and vice versa.

As FIG. 4B also shows, information related to, derived from, or which is part of, the generated solution may be used to update one or more of the data sources 412, as shown by the dashed line coupling the solutions 430 with the data sources 412. As FIG. 4B also shows, in some embodiments, data from the plurality of data or information sources 412 may be input to the enterprise 404, i.e., may affect operations of the enterprise 404, as indicated by the dashed line connecting the data sources 412 with the enterprise 404.

Thus, in various embodiments, outputs or data from any of the components or processes in the system may affect or be used by any other of the components or processes in the system.

FIG. 5: Operation of Dynamic Model Feedback Methods

FIG. 5 is a flowchart diagram illustrating operation of dynamic model feedback methods for an enterprise, according to one embodiment of the invention. As used herein, an “enterprise” may be a process, a manufacturing operation, a system (e.g., an e-commerce system) or any other type of enterprise.

As shown, in modeling, optimizing or controlling a process, system or enterprise, the system may receive goals and objectives 222 and may also receive constraints 224. The goals and objectives may comprise any of various types of objectives for the system or process being modeled or optimized. For example, the goals and objectives may relate to a desired profitability, cost factors, production amounts, e.g., to maximize production, or other types of goals and objectives. It is noted that the goals and objectives may vary depending on the type of system or process being optimized or modeled. For example, if the system is a manufacturing plant, the goals may relate to the amount, quality and/or cost of the items being produced by the manufacturing plant. If the system or process relates to a business organization, the goals and objectives may relate to customer satisfaction, profitability, lowered cost, etc. The constraints 224 may also depend on the type of system or process being modeled or optimized. Where the process or system is a manufacturing plant, the constraints may relate to specific constraints related to the materials being used in the manufacturing process, or constraints related to the manufacturing process itself. Exemplary types of constraints include throughput or production rates of machinery, quantities of bulk material received from various sources, percentage combinations of feed stocks or bulk materials in creating an item, prices of various commodities etc.

As shown, these goals and objectives 222 and constraints 224 may be provided to create a model 226. In prior art systems, the models that have been created using goals and objectives 222 and the constraints 224 have generally been static or semi-static models, i.e., models that are updated very infrequently such as once every six months, once every year, etc. According to one embodiment of the invention, the goals and objectives 222 and the constraints 224 are used to create dynamic models 226 referred to as dynamic cost models 226. The dynamic cost models 226 may then be used to generate a schedule 228. For example, where the system being modeled or optimized is a manufacturing plant, the dynamic cost model 226 may be used to generate a schedule 228 for the operation of the manufacturing plant wherein the schedule is designed according to the model 226 to accomplish the goals and objectives 222 subject to the constraints 224.

Line 260 shows a separation between elements (e.g., tasks, inputs, outputs) related to planning a process, system or enterprise (i.e., above the line) and elements related to implementing a process, system or enterprise. Those items and/or processes above line 260 (i.e., receiving goals and objectives 222, receiving constraints 224, dynamic cost models 226, schedule 228) are related to planning a process, system or enterprise. Similarly, those items and/or processes below line 260 (i.e., dynamic models 232, process 234, external input 242, internal input 244) are related to implementing a process, system or enterprise.

The system or process being controlled may have one or more dynamic models which control or model the manner in which the various systems in the overall system or enterprise operate. For example, where the system being modeled or controlled is a manufacturing plant, the plant may include a plurality of different models which represent the various equipment or systems operating in the manufacturing plant. As shown, these dynamic models 232 are used in controlling the process or system 234. These dynamic models 232 are dynamic, i.e., their operation is adjusted dynamically based on various inputs such as external input 242 and internal input 244. Thus, as situations change inside the manufacturing plant, various types of internal input or events 244 may be generated. For example, a particular piece of machinery may break down, labor shortages or labor strikes may occur or other internal activities may occur which cause corresponding changes in the dynamic models 232. The external input 242 may represent various external input or events which may occur which may also operate to change the dynamic models 232 in some way. For example, if the cost of a certain bulk material changes, or supply shortages occur, etc., these external events or input 242 may be provided or received and result in corresponding updates to the dynamic models 232. The changes or modifications made to the dynamic models 232 may result in changes to the operation of the process 234.

In prior art systems, the various events or internal and external inputs 244 and 242 may result in changes to the dynamic models 232 actually operating within the process or manufacturing plant. However, these external events have not been propagated to the higher level models 226 and were not taken into account in these higher level models 226. Thus, the schedule 228 used to control the process or plant in most instances became outdated since the schedule 228 was not generated based on more recent events which have occurred. Thus, the prior art systems which utilize static models in creating the schedule 228 suffered from the inability to receive and utilize external or internal event data that affected the dynamic models 232 controlling the process 234.

According to one embodiment of the invention, the external and internal events 242 and 244 which are provided to adjust the dynamic models 232 are also propagated upward as shown by arrows 250 to the various higher level components in the system. In one embodiment, information associated with or describing the inputs may be propagated upward as shown by arrows 250. For example, information may be propagated that describes suggested actions.

Thus, the changes made to the dynamic models 232 may also propagate back to one or more of the goals and objectives 222, the constraints 224, the dynamic cost models 226, and the schedule 228. Thus, for example, if one or more events 242 or 244 occur which affect the dynamic models 232 and hence the operation of the process 234, one embodiment of the invention also provides this information to the dynamic cost models 226. These dynamic cost models may change accordingly and hence produce a different schedule 228 which is more accurate or optimized for the current state of events. The new schedule 228 may then be used to control the dynamic models 232 and the process 234 wherein the new schedule is more intelligently based on the recent events 242 and 244 affecting the dynamic models 232 and the process 234. As another example, the various events 242 and 244 may be provided upward and result in an adjustment of one or more of the goals and objectives 222 or the constraints 224. Adjustments in either the goals and objectives 222 or the constraints 224 may result in a corresponding change to the dynamic cost models 226 which may then result in a corresponding change to the schedule 228. Here again, the propagation of this event data 242 and 244 to the higher level parts of the system result in more intelligent scheduling of the process based on the current information or current events.

The propagation of inputs 242 and 244 to the other parts of the system may occur substantially in real time. As used herein, the term “real time” may refer to minutes or hours. In some enterprise systems, the term “real time” may refer to a time period within several days. As used herein, the definition of the term “real time” may depend on the particular application or enterprise being controlled. For example, in a certain type of manufacturing plant, the term “real time” may refer to propagating the information regarding the inputs (or the inputs themselves) within a matter of minutes or hours. In another enterprise application, the term “real time” may refer to propagating the information regarding the inputs substantially immediately, i.e., within a few seconds.

The term “real time” may generally refer to an amount of time between receipt of the inputs and propagation of the information associated with the inputs, wherein the information is propagated and used by the enterprise within a sufficient time period to allow the enterprise to use this information in a useful way, i.e., to allow the enterprise to directly account for the inputs, and without the information associated with the inputs becoming “stale” and hence less valuable to the enterprise.

As one example, if a machine in the manufacturing plant breaks down or requires repairs, this information may be provided as shown by arrow 250 to be used as an additional constraint 224. This additional constraint 224 may result in an adjustment of the dynamic cost model 226 hence resulting in an adjustment of the schedule 228. This new schedule 228 may thus better reflect the current state of the equipment present in the manufacturing plant.

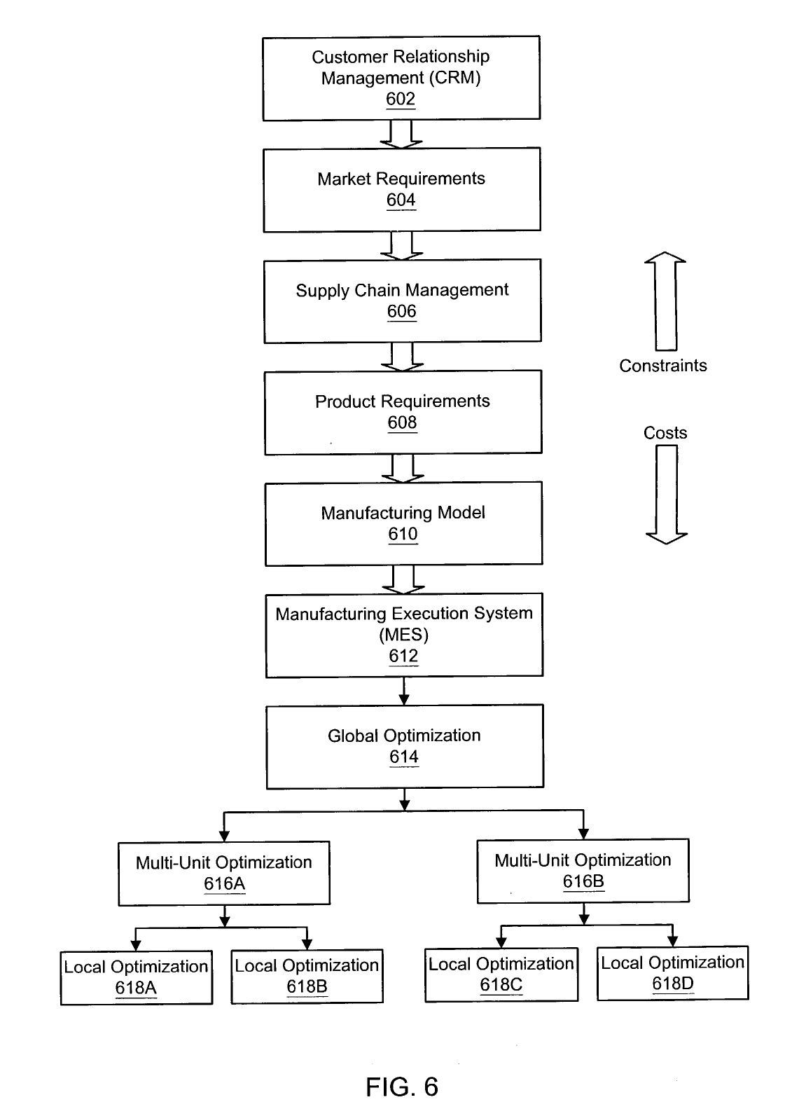

FIG. 6: Realtime Enterprise Optimization (REO) Hierarchy

FIG. 6 is a flowchart diagram illustrating one embodiment of a general hierarchy for a Real-time Enterprise Optimization (REO) system. It should be noted that the hierarchy shown is intended to be exemplary only, and is not intended to limit the system or process to any particular form or organization. Thus, in various embodiments, the components or process in the hierarchy may be different, or may be in a different order than shown in FIG. 6.

In one embodiment of the present invention, each level of decision may be a function of other decisions, and thus may not be separated from them if optimal performance of the enterprise is the goal. For example, in the embodiment shown in FIG. 6, the plan may affect the schedule, the schedule may affect the optimal operation of multiple production units, and the operation of the units may be constrained by the available control. As shown in FIG. 6, the different levels of technology that work together to implement the REO system and the seamless interface between these levels, including constraints coming from the real-time information in the process, and goals from satisfying the customer demands, may all operate together to provide top-to-bottom (or bottom-to-top) enterprise optimization.

Information may be extracted between each level. For example, although the information needed for planning may not depend specifically on the detailed dynamics that are used for automated process control (APC), important information generally has to be passed between each major function. The term costs is shown flowing downward in FIG. 6. Typically, goals will also flow down from the customer demands (not shown) or from changing corporate objectives (not shown). Constraints typically flow in the opposite direction of goals (i.e., upward) from the unit operations. These constraints derived from unit operations are important for the optimal performance of the operation or process.

As the embodiment of FIG. 6 shows, Customer Relationship Management (CRM) 602 may interact with Market Requirements 604; Market Requirements 604 may interact with Supply Chain Management (SCM) 606; Supply Chain Management 606 may interact with Product Requirements 608; Product Requirements 608 may interact with Manufacturing Model 610; Manufacturing Model 610 may interact with Manufacturing Execution System (MES) 612; Manufacturing Execution System (MES) 612 may interact with Global Optimization 614; Global Optimization may interact with Multi-Unit Optimization 616A and 616B; and Multi-Unit Optimization 616A and 616B may interact respectively with Local or Single-Unit Optimization 618A-618B and 618C-618D. It is noted that feedback or interaction, e.g., information, may flow in both directions, with constraints flowing up the chain or hierarchy of the REO architecture, and costs and/or goals flowing upwards, as shown.

Examples of goals and constraints flowing from various elements in the architecture not specifically illustrated in FIG. 6 may include any of the following, among others:

Customer Relationship Management goals may include forecasts, prices, demands, any and/or all of which may affect the plan;

Customer Relationship Management constraints may include constraints, BPR, actual production affects Customer Relationship Management;

Production and Business Planning goals may include plans, prices, demands, any and/or all of which may affect the schedule;

Production and Business Planning constraints may include schedule constraints, production, quality limits the affect of the Plan;

Production Scheduling goals may include schedule affects available production;

Production Scheduling constraints may include actual production constraints affect the Schedule;

Multi-Unit Optimization goals may include optimization affects control setpoints;

Multi-Unit Optimization constraints may include control constraints affect optimal production available in units.

Advanced Control goals may include control targets affect properties (e.g., inferential property models);

Advanced Control constraints may include unmeasured and measured disturbances constrain available control.

It is noted that optimization may be viewed in a hierarchy with global optimization at the top of the hierarchy, followed by multi-unit optimization, and with single-unit or local optimization at the bottom of the hierarchy, as shown in FIG. 6. For example, in an energy production application, single-unit or local optimization may relate to the operation of individual energy production plants, e.g., a coal-fired generator or a nuclear plant, while multi-unit optimization may be performed on aggregates of power generators. Finally, global optimization may be performed at the super-aggregate level, where perhaps multiple power generation plants, each comprising multiple generators, may be considered together, and optimized in accordance with global constraints and/or objectives. It is noted that the systems and methods described herein are broadly applicable to both homogeneous and heterogeneous enterprises.

One embodiment of the real-time enterprise optimization (REO) system described herein may use non-linear, empirical modeling technology and robust real-time optimization and control solutions. The REO system may be useable to solve some of the most difficult and challenging problems in an enterprise, including manufacturing and supply chain management. Embodiments of the invention may be used in various fields, including chemicals, polymers, energy generation and distribution, pulp and paper, consumer goods, cement, minerals, and mining, among many others. It is also contemplated that various embodiments of the present invention may be applicable to service enterprises, including, for example, financial, management, diagnostic, analysis, distribution, and engineering services, among others.

One embodiment of the REO system includes elements of advanced planning and scheduling for the enterprise and additional functionality that may include simulation for predictive analysis and scenario evaluation and optimization. In this embodiment, the REO system may be layered on top of traditional optimization and control products, such as those available from Pavilion Technologies of Austin, Tex., which may help manufacturers or other enterprise managers understand, control, and optimize their processes. For example, a multivariable predictive controller and integrated process optimizer may be useable for controlling and optimizing single and connected processes. This architectural foundation may provide common and consistent models for all applications, a key element for integrated real-time business decisions. In addition, real-time enterprise optimization may require decision support systems that are congruent with enterprise objectives and representative of the natural workflow of people, plants, and business systems. Optimizing an enterprise effectively may also require the use of a consistent set of data and models for long-term strategic planning, short-term tactical planning and operational analysis.

One embodiment of the REO system may include an automated decision-making environment that extends beyond assumptive historical data and transaction integration. More specifically, the REO system may be based upon real-time measurements, dynamic activity based costing models, and a suite of model-based analytic and optimization applications, as described in detail above with reference to FIG. 4B. For more information regarding dynamic activity based costing, please see U.S. Provisional Application Serial No. 60/382,301 titled “Dynamic Cost Accounting” and filed May 22, 2001, which was incorporated by reference above.

Thus, various embodiments of the system may link day-to-day business decision making with enterprise goals through flexible, modular, and scalable solutions that coordinate strategies, tactics, logistics, and operations. Dynamic models representing multidimensional abstractions of critical planning and performance data may be a key element of the system. The use of models based on these data may create a real-time knowledge based system which may deliver factual information rather than assumptions, and may have predictive capabilities as opposed to just a historical perspective. Additionally, the system may be operable to quantify the impact of operational changes, and deliver alternative strategies and tactics to meet the enterprise goals.

Thus, the system described herein may link analytical and optimization software with structured business processes to implement a centralized control framework. This approach may enable the system to manage enterprise scale optimization because such problems generally require coordination of strategic, tactical, logistics, and operational elements of the business. In general, enterprise optimization decision support environments preferably operate to synthesize and deliver information for rapid decision-making and end-to-end collaboration on a time scale that supports the business process cycles. Current enterprise resource planning (ERP), supply chain, and other enterprise systems may lack the functionality necessary to perform as a complete enterprise optimization system due to their inability to adequately handle time and state information. A command and control system approach may be operable to synchronize operations, facilitate collaboration across the enterprise, provide contextual information with consistency in objectives and constraints, and provide meaningful and measurable performance indicators.

The primary functions of a command and control system may include intelligence gathering, situation analysis, strategic planning, operational directives, logistics, asset management, and simulation. These functions may create a context that connects both physical and business processes so that plants are agile and responsive to business initiatives. There are two main categories of optimization: algorithmic, which may determine the optimal operating parameters of physical processes; and business processes, which may establish work processes, organizational structure and interfaces between groups. In optimizing the many operations and sub-systems of the enterprise, the REO system may provide multiple algorithmic choices. In other words, the REO system may be operable to use any of a variety of algorithms, including, for example, simple linear programming (LP), genetic algorithms, evolutionary computing, expert systems, various search techniques, and/or any other types of algorithm.

The business process optimization command and control structure may be a predictive management system with targets aimed at various expressions of customer value. The planning, financial, and operations systems help management formulate control actions to respond to measured or forecasted changes in the business. In this feedback control system, the abstraction and translation of real-time data into contextual information is critical for achieving management goals. It provides a mechanism to reevaluate plans based on significant deviations between assumptions and real-time performance estimates that are consistent with strategic objectives. This approach is essential because objectives change rapidly and out of date or incorrect information is not only ineffective but can be detrimental to an organization if important decisions are based upon that information.

Models and Model Warehousing

Modeling and simulation may lead to a new way of doing business, rather than just playing a supporting technology role. Model-based REO solutions may be a pervasive universal tool for product and process design, production planning and analysis, and business process evaluation. Modeling and simulation may form a basis for business and production decisions.

Without accurate process and financial models using the most current data, it is impossible to predict how a plant will perform when producing a particular product under various conditions, and thus whether or not a product may be made profitably, on time, and to the customer's specification. Models encapsulate process knowledge that describes the physical or business attributes of a system and provides predictive capabilities to support business decisions. Deploying integrated operation and management technology using consistent models may provide a way to achieve the agility, flexibility, and responsiveness necessary to take advantage of the opportunities afforded by the Internet economy.

As mentioned above, a key aspect of one embodiment of the present invention is the use of dynamic, non-linear models with real-time connectivity to operational data. With continual real-time data feeds, the dynamic models may evolve over time to update key cost variables and other production attributes as the state of the process changes. For example, in a production system, the models may generate up-to-date production capability information such as cost, quality, yield, and capacity while communicating that information to enterprise planning, scheduling, and costing systems. Consequently, the systems may have a consistent view of production capabilities.

Using consistent models across different levels of detail and complexity may be essential for accurate decision-making. Thus, the models may: (i) share common data; (ii) have a consistent representation of relationships; and (iii) work in tandem in an integrated solution. In one embodiment, some of the models used in REO are abstractions and translations of the very models used to implement model predictive control on the individual and multiunit production optimization applications.

This dynamic activity model-based approach of the system is unique. Since the method revolves around models and not data it becomes a matter of knowledge management as opposed to data management; resolving many of the latency issues with periodic updates to data warehouses and the associated load balancing operational difficulties and unwieldy maintenance complexities of prior art systems.

In one embodiment, the models are stored in a model or profile warehouse for convenient access and management. The models and their results may represent multi-dimensional abstractions and translations of planning and performance data. For instance, in a factory application, the warehouse may include a factory cost profile that embodies information about unit cost factors, fixed costs and allocation methods. A production profile may characterize information about production rate, cycle times, quality summaries, and running production tallies. The profile warehouse may provide a consistent set of models with different levels of fidelity dependent on the needs and end purpose or goals of the enterprise.

Modular, Flexible, Scalable, and Layered Approach to REO

In one embodiment, the various components of the REO system are modular so that users need only use those portions required for their particular operations. This modular architecture provides substantial flexibility in that it does not force the user to any particular set of business processes or methodology. The REO modular architecture may also accommodate changes to the business readily so that reconfiguration of the process or changes to the enterprise may be handled with ease. The object and component model based approach may thus ensure that REO is scalable to meet the needs of operations of any size. In one embodiment, enterprise optimization may begin with optimization of manufacturing operations; REO may be layered on top of modeling, supervisory control, and optimization products which may guarantee model consistency while providing two-way communication between the applications.

User Interface as Web Based Portal

In one embodiment, REO may use a web portal for the user interface. Web based portals may provide a mechanism to dynamically deliver required information through the use of common, (inexpensive) web browsers. Web based portals may also provide access to the enterprise from anywhere at anytime so users may obtain the information they need when they need it, and where the information may be presented in a predefined context. The thin client architecture of a web browser may make the application easy to maintain, administer, support and control.

The use of web portals for access to and/or control of enterprise operations and data necessitates the inclusion of greater security measures in the system. For example, in the simplest case, web portal access may be controlled by secure login procedures. In more sophisticated implementations, the enterprise may be partitioned into various security layers or domains to ensure safety and/or privacy of information. For example, in a chemical production enterprise where safety issues are a greater concern, control of certain process, e.g., those involving hazardous chemicals or critical processes, may be restricted to on-site personnel. As another example, to ensure information security, data flow in the enterprise may be restricted, e.g., with respect to access or direction. For example, sources of control commands for an advanced process control (APC) system may be restricted to particular processes or persons, or, feedback information among processes may be constrained to flow between certain processes or components and not others. Similarly, information may be allowed to flow in one direction, say, from component/process A to component/process B, but not allowed to flow in the opposite direction, e.g., from component/process B to component/process A.

Various embodiments of the system may support the business processes of developing plans, scheduling production, implementing and executing the production plan, and measuring the performance. This may occur in a coordinated real-time cycle, allowing management to make effective adjustments during a re-planning cycle triggered by any deviations from the plan.

For example, the system may provide workflow management for establishing the plan framework by specifying the objectives, constraints, and metrics for the system. Demand, price, and costs of capital are some of the general assumptions used for forecasting purposes, among others. Capacity, quality, and costs are some of the planning factors used for determining plant capability, among others. In a chemical plan application, the system may generate operations plans with optimal product mix and quantities from the assumptions and planning factors. The system may use simulation to estimate the impact of assumptions and choices, perform what-if calculations by changing factors, and determine changeover capabilities to achieve greater confidence in available-to-promise (ATP) plans. Based upon the results of the simulation, modification of the plan may be necessary. Implementing the plan is a matter of setting up key performance measures, developing schedules, and initiating production.

Properly identifying significant deviations from assumptions and constraints so that a plan may be modified to compensate for errors in market forecasting and financial projections may depend upon accurate measurement of performance. Dynamic activity based costing models, using parameter values updated by links to the production system, may be the key to providing accurate real-time cost estimates.

A layered approach to product integration may form the basis of a modular and scalable control and optimization solution. A “learn, predict, optimize, control, and profit” paradigm may have a one-to-one product category correspondence with each layer, thus adding functionality.

Using REO, front-end business processes may be linked and synchronized with plant optimization and information processes. Achieving this typically requires having a strong manufacturing architectural foundation based on common models, and having the ability to directly optimize manufacturing processes. Enterprise optimization may begin on the plant floor, unit-by-unit, extending to connected units, sites, and enterprises. Much of the value from optimizing an enterprise is lost if manufacturing processes cannot react to improved business decisions.

On-line plant and unit optimizer models may be integrated with planning and scheduling models. This ties consistent, accurate, integrated business decisions across the enterprise. A consistent understanding of true plant capacity and constraints across the plant may result in a level of agility in business decision-making that was not previously possible. This understanding may allow management to run the plants at their most profitable constraints and with a high degree of confidence.

Non-physical process models may be built, these non-physical process models may be used to optimize customer portfolio profitability for the financial services, telecommunications, and pharmaceutical industries, among others.

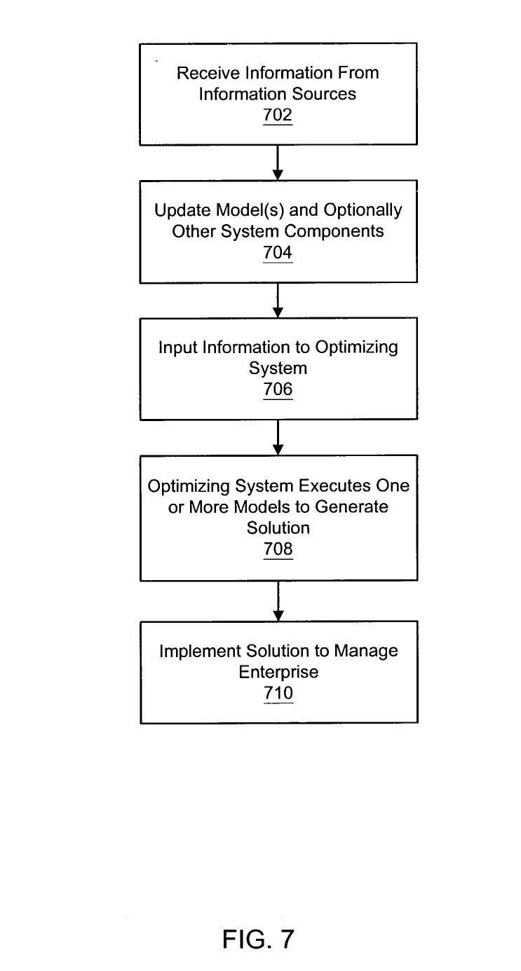

FIG. 7—Method for Optimizing an Enterprise

FIG. 7 is a high-level flowchart diagram of one embodiment of a method for optimizing an enterprise. It is noted than in various embodiments, one or more of the steps may be performed in a different order than shown, or may be omitted. Additionally, other steps may be performed as desired.

As FIG. 7 shows, in 702, information may be received from any of the plurality of information sources 412, including, for example, external information and/or internal information, including historical, current, and/or projected information, as well as possibly synthesized information, as described above.

Then, in 704, at least one of the plurality of models 410 may be updated in accordance with the received information. For example, data, parameters, and/or coefficients of a model may be updated. In another embodiment, one or more models may be added, removed, or replaced, depending on the information received. In other embodiments, other components of the REO system may be updated, including, for example, the information or data sources 412, the optimizers 414, and/or the constraints and/or objectives 416, among others. In other words, any component or aspect of the REO system may be updated as desired. As mentioned above, in some embodiments, such updates may be performed asynchronously.

In 706, at least a portion of the received information may be input to the optimizing system (e.g., optimizers 414 and/or constraints and/or objectives 416). For example, in one embodiment, the received information may include updated objectives and/or constraints which may affect the solution(s) generated by the optimizer(s).

Then, the optimizing system (e.g., one or more of the optimizers 414) may execute one or more of the plurality of models 410 to generate the solution 420, as indicated in 708. As noted earlier, the optimizing system preferably generates the solution 430 subject to the one or more objectives and/or constraints 416. The solution may be any type of information or decision that is germane to enterprise operations. For example, the solution may include one or more of: production schedules, product pricing, investment strategies, diagnoses, product mixes, and/or any type of management decision, plan, or strategy, among others.

Finally, in 710, the solution may be implemented, e.g., to manage the enterprise. In other words, as mentioned above, the solution may be implemented by human actions, programmatically, or a combination of the two. For example, in a polymer production application, the solution may comprise a polymer production schedule, which may include information related to product mixes, volumes, etc. In an embodiment where an automated process control (APC) is coupled to the optimizing system and the polymer production lines, the polymer production schedule may be implemented automatically, i.e., programmatically, such that human intervention is not required to put the schedule into effect. In an embodiment where the plant requires human control, one or more plant operators may operate the polymer production lines in accordance with the generated production schedule. Of course, the example given (polymer production) is but one of many example uses of the present invention, as noted above.

Thus, various embodiments of the distributed asynchronous enterprise optimization systems and method described herein may provide improved means for enterprise-wide optimization. More specifically, the fact that the components of the system may be distributed across multiple computers, and which may communicate and operate asynchronously over a network, e.g., the Internet, may allow for flexible, integrated, and substantially real-time, optimization of heterogeneous systems and operations of an enterprise. Moreover, a modular architecture of the system may allow easy customization of the system for specific applications or types of enterprise.

While the present invention has been described with reference to particular embodiments, it may be understood that the embodiments are illustrated and that the invention scope is not so limited. Any variations, modifications, additions and improvements to the embodiments described are possible. These variations, modifications, additions and improvements may fall within the scope of the invention as detailed within the following claims.

We claim:

1. A computer-implemented system for managing an enterprise, comprising:
a plurality of computer systems, wherein the plurality of computer systems are coupled over a network, and wherein the plurality of computer systems store and implement:
a plurality of models, wherein one or more of the plurality of models comprises a dynamic model representing a respective sub-system or process of the enterprise, and wherein at least two of the plurality of models are interdependent; and
an optimizing system, wherein the optimizing system is operable to receive information related to the enterprise from a plurality of information sources, and use one or more of the plurality of models to generate a solution, wherein the solution is usable in managing the enterprise;
wherein at least a portion of the system operates in an asynchronous manner.

2. The system of claim 1, wherein, in storing and implementing the plurality of models and the optimizing system, the plurality of computer systems:
store and/or execute the plurality of models on a first subset of the plurality of computer systems; and
store the optimizing system on a second subset of the plurality of computer systems.

3. The system of claim 2, wherein the first subset of the plurality of computer systems and the second subset of the plurality of computer systems have no computer systems in common.

4. The system of claim 2, wherein the first subset of the plurality of computer systems and the second subset of the plurality of computer systems have at least one computer system in common.

5. The system of claim 1, wherein the optimizing system comprises:
a plurality of optimizers, wherein at least a subset of the plurality of optimizers are interdependent; and
one or more constraints and/or objectives;
wherein the optimizing system is operable to generate the solution subject to the one or more constraints and/or objectives.

6. The system of claim 5, wherein the one or more constraints and/or objectives comprise:
two or more interdependent constraints and/or objectives.

7. The system of claim 5, wherein at least a portion of the solution is implementable by a human to manage the enterprise.

8. The system of claim 5, wherein at least a portion of the solution is programmatically implementable to manage the enterprise.

9. The system of claim 5, wherein a first portion of the solution is programmatically implementable to manage the enterprise, and wherein a second portion of the solution is implementable by a human to manage the enterprise

10. The system of claim 5, wherein at least one of the models comprises one of the plurality of information sources.

11. The system of claim 5, wherein at least one of the models comprises one of the one or more constraints and/or objectives.

12. The system of claim 5, wherein at least one of the information sources comprises one of the one or more constraints and/or objectives.

13. The system of claim 5, wherein the one or more constraints and/or objectives comprises at least one constraint and at least one objective.

14. The system of claim 1, wherein said dynamic models and/or said optimizing system are updated one or more of:
at least twice per annum;
at least once per month;
at least twice per month;
at least weekly;
at least daily;
at least hourly;
at least once per minute;
at least once per second; and
at least once per millisecond.

15. The system of claim 1, wherein said plurality of information sources are comprised on two or more computer systems.

16. The system of claim 1, wherein, the system is operable to detect changes in data from the plurality of information sources, and update:
one or more of the dynamic models; and/or
the optimizing system.

17. The system of claim 1, wherein the plurality of information sources provide information related to one or more of:
cost of resources;
cost of capital;
raw materials;
enterprise operations and/or processes;
network management;
performance;
equipment;
energy;
competitors;
marketing;
sales;
product specifications;
geographic location;
economic factors;
ambient conditions;
customer information;
environmental information;
executive instructions; and
synthesized information related to the enterprise.

18. The system of claim 17, wherein said information related to energy comprises one or more of:
current availability of energy;
projected availability of energy;
current price of energy; and
projected price of energy.

19. The system of claim 17, wherein said information related to sales comprises one or more of:
current sales; and
projected sales.

20. The system of claim 17, wherein said information related to raw materials comprises one or more of:
current availability of raw materials;
projected availability of raw materials;
current price of raw materials; and
projected price of raw materials.

21. The system of claim 17, wherein said information related to economic factors comprises one or more of:
current and/or projected stock prices;
current and/or projected debt rating; and
current and/or projected interest rates.

22. The system of claim 17, wherein said information related to equipment comprises information related to one or more of:
equipment performance;
equipment maintenance; and
equipment status.

23. The system of claim 1, wherein the plurality of models includes one or more of:
a costing model;
a revenue model;
a tax model;
an organizational model;
a maintenance model;
a supply chain model;
a distribution model;
a sales model;
a marketing model;
a process model;
a production model;
a product model;
a customer model;
an equipment model;
an economics model;
an environmental model;
a performance model;
a logistics model;
a scheduling model; and
a model of one or more of the plurality of models.

24. The system of claim 1,
wherein said plurality of models and said optimizing system are operable to receive information related to the enterprise from the plurality of information sources, and use one or more of the plurality of models to generate a solution;
wherein at least one of the plurality of information sources comprises one or more systems and/or process of the enterprise; and
wherein said receiving and said generating are performed iteratively.

25. The system of claim 1,
wherein said plurality of models and said optimizing system are operable to receive information related to the enterprise from the plurality of information sources, and use one or more of the plurality of models to generate a solution;
wherein at least one of the plurality of information sources comprises one or more systems and/or process of the enterprise; and
wherein said receiving and said generating are performed recursively.

26. The system of claim 1, wherein said enterprise relates to one or more of:
manufacturing;
polymer production;
chemical production;
energy production;
energy distribution;
financial services; and
engineering.

27. The system of claim 1, wherein said plurality of models and/or said optimizing system are operable to programmatically retrieve input information.

28. The system of claim 27, wherein, in said programmatically retrieving input information, the plurality of models and/or said optimizing system are operable to:
monitor input information from the one or more information sources; and
if a value or change in value in an element of the input information matches one or more criteria, retrieve said element; and
dynamically update the plurality of models and/or the optimizing system in accordance with the retrieved element.

29. The system of claim 28, wherein the plurality of models and/or the optimizing system are operable to programmatically retrieve input information and dynamically update the plurality of models and/or the optimizing system in an asynchronous manner.

30. The system of claim 1, wherein said plurality of models includes one or more of:
a neural network;
a support vector machine;
an analytic model;
a statistical model;
a regression model;
an empirical model;
a first principals model;
a non-linear model;
a rule-based model; and
an expert system model.

31. A method for managing an enterprise, wherein the method is implemented by a plurality of networked computer systems, the method comprising:
receiving information related to the enterprise from a plurality of information sources;
updating one or more of a plurality of models using said received information, wherein at least one of the plurality of models comprises a dynamic model representing a respective sub-system or process of the enterprise, and wherein at least two of the plurality of models are interdependent;
inputting at least a portion of the received information into an optimizing system; and
the optimizing system executing one or more of the plurality of models to generate a solution, wherein the solution is usable in managing the enterprise;
wherein at least a portion of the method is performed in an asynchronous manner.

32. The method of claim 1, wherein the optimizing system comprises:
a plurality of optimizers, wherein at least a subset of the plurality of optimizers are interdependent; and
one or more constraints and/or objectives;
wherein the optimizing system is operable to generate the solution subject to the one or more constraints and/or objectives.

33. The method of claim 32, wherein at least a portion of the solution is implementable by a human to manage the enterprise.

34. The method of claim 32, wherein at least a portion of the solution is programmatically implementable to manage the enterprise.

35. The method of claim 31, wherein said receiving and said inputting are performed programmatically.

36. A method of modeling, optimizing or controlling an enterprise, the method comprising:
creating a plurality of first dynamic models in response to one or more of goals, objectives, and constraints;
generating one or more solutions for the enterprise in response to said plurality of first dynamic models, wherein the one or more solutions are generated according to said plurality of first dynamic models to accomplish the goals and/or objectives subject to the constraints;
creating a plurality of second dynamic models in response to said one or more solutions, wherein the plurality of second dynamic models control or model the manner in which various systems in the enterprise operate;
receiving inputs to the plurality of second dynamic models;
propagating information associated with the inputs to one or more of: the plurality of first dynamic models and the one or more solutions for the enterprise; and
modifying one or more of: goals, objectives, constraints, the plurality of first dynamic models, and the one or more solutions for the enterprise in response to said propagating the information.

37. The method of claim 36, further comprising
modifying the plurality of second dynamic models in response to the inputs.

38. The method of claim 36,
wherein said propagating information associated with the inputs is performed substantially in real time when the inputs are received.

39. A method of modeling, optimizing or controlling an enterprise, the method comprising:
receiving goals and objectives for the enterprise;
receiving constraints of the enterprise;
creating a plurality of first dynamic models in response to one or more of said goals, objectives, and constraints;
generating one or more solutions for the enterprise in response to said plurality of first dynamic models, wherein the one or more solutions are designed according to said plurality of first dynamic models to accomplish the goals and objectives subject to the constraints;
creating a plurality of second dynamic models in response to said one or more solutions, wherein the plurality of second dynamic models control or model the manner in which the various systems in the enterprise operate;
receiving inputs to the plurality of second dynamic models;
modifying the plurality of second dynamic models in response to the inputs;
propagating information associated with the inputs to one or more of: goals, objectives, constraints, the plurality of first dynamic models, the one or more solutions for the enterprise; and
modifying one or more of: goals, objectives, constraints, the plurality of first dynamic models, and the one or more solutions for the enterprise in response to said propagating the information.

40. A method of modeling, optimizing or controlling a process, system or enterprise, the method comprising:
receiving goals and objectives;
receiving constraints;
creating a plurality of first dynamic models in response to said goals, objectives, and/or constraints;
generating a plurality of solutions for the process, system or enterprise in response to said plurality of first dynamic models;
wherein the plurality of solutions are designed according to said plurality of first dynamic models to accomplish the goals and objectives subject to the constraints;
creating a plurality of second dynamic models in response to said plurality of solutions;
wherein the plurality of second dynamic models control or model the manner in which the various systems in the overall process, system or enterprise operate;
receiving external inputs to the plurality of second dynamic models, wherein the external inputs are external to the process, system or enterprise;
receiving internal inputs to the plurality of second dynamic models, wherein the internal inputs are internal to the process, system or enterprise;
modifying the plurality of second dynamic models in response to the external inputs or the internal inputs;
propagating the external inputs or the internal inputs to one or more of: goals, objectives, constraints, the plurality of first dynamic models, the plurality of solutions for the process, system or enterprise;
modifying one or more of: goals, objectives, constraints, the plurality of first dynamic models, the plurality of solutions for the process, system or enterprise in response to said propagating of the external inputs or the internal inputs.
